(19) United States
(12) Patent Application Publication
(10) Pub. No.: US 2017/0048455 A1
(43) Pub. Date: Feb. 16, 2017

(54) Optic for enabling instantaneously 360° Degree Panoramic Video of the Surroundings

(71) Applicant: Douglas Arnold Brand, Easton, PA (US)

(72) Inventor: Douglas Arnold Brand, Easton, PA (US)

(21) Appl. No.: 14/823,793

(22) Filed: Aug. 11, 2015

(51) Int. Cl. H04N 5/232; H04N 5/225; G03B 17/56; G03B 15/12

(52) U.S. Cl. CPC H04N 5/23238; G03B 15/12; H04N 5/2253; G03B 17/565

(57) ABSTRACT

A panoramic optical element that integrates a mirrored sphere surface positioned at a specific length perpendicular to the focus point of the video camera. The sphere reflects the 360° environment into the lens of the video camera installed below the rear view mirror of a vehicle. The use of one video camera to capture 360° field of view is significant because it does not employ any moving parts to capture the 360° image. The recorded image output is in the form of a circular video image that can later be converted by using a software package that digitizes the pixel points into a rectilinear image. The embodiment can be used to capture a continuous loop recording of the operation of a motor vehicle by capturing the outside environment along with the vehicle's operator and incumbents or passengers or for other applications where a 360° panoramic view is required.

### BACKGROUND

I am proposing an economical manner in providing a 360° view of their environment. Currently there are lenses that can capture the surroundings. The standard 35 mm lens can capture only 39.6° horizontal view while the theoretical greatest angle can only be 180° degrees. For reference the human eye can view 140° horizontal view. This invention will allow a single digital video camera to capture 360° recordings of the surroundings. The idea came to me when my fiancée was involved in a car accident and there were no witnesses. My idea is to establish a simple one camera system mounted below the rear view mirror of a car that can capture everything that is happening during the operation of a motor vehicle including the driver's actions. This invention could also be used to lower the cost of security cameras as well.

Others have tried to solve this by adding multiple cameras mounted around the vehicle and integrate the videos from the individual cameras into a computer. Other solutions are to add a single forward facing dashboard camera such as the ones Police currently employ into their vehicles. My idea consolidates this into a simple one camera one optic execution which provides 360° video capture.

### BRIEF SUMMARY OF THE INVENTION

This invention uses a fixed optic mounted to a video camera which can capture a 360° horizon. No moving internal components are used for the optic or camera other than the shutter. This invention adds simple conical mirror fixture to a digital video camera. The conical mirror fixture is based on the principal of fight or image in the plane perpendicular to the axis of the reflective conical surface which is reflected by the conical mirror through a conventional video camera lens. The image captured is circular image that is later reconfigured using software into a rectangular image for easier viewing. The video image stored on the disc can be overwritten at some interval to save disk space capacity.

### BRIEF DESCRIPTION OF THE DRAWINGS

FIG. 1. FIG. 1 is a longitudinal section through the panoramic receiving optic.

FIG. 2. FIG. 2 is a longitudinal section through the panoramic receiving optic mounted on the video camera.

FIG. 3. FIG. 3 represents a plan of a surrounding to be captured by the video camera.

FIG. 4. FIG. 4 represents the image that is captured using the panoramic optic. The images in FIG. 3 are represented in the exact image that is captured.

FIG. 5. FIG. 5 represents the spherical panoramic optic mounted on the rear view mirror of a automobile.

FIG. 6. Represents the final image as modified from a circular image to a rectangular image using a software package.

### DETAILED DESCRIPTION AND BEST MODE OF IMPLEMENTATION

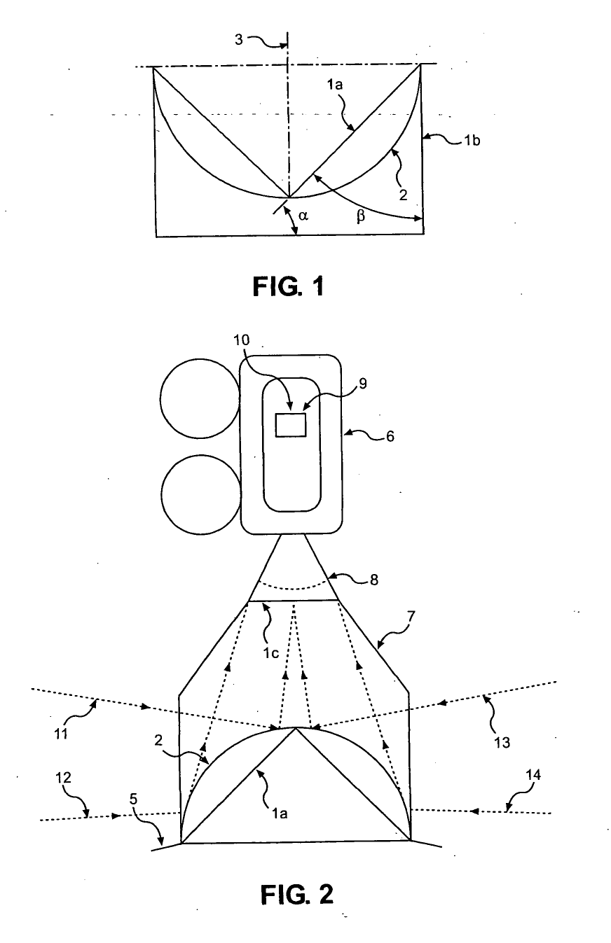

The panoramic receiving optic depicted in FIG. 1 is comprised of a suitable optically reflective surface mounted or adhered to a solid material base which is the reflective surface 1a, is a surface of rotation about axis 2, thus forming an inverted cone or mirror sphere. The angles alpha and beta may be equal to minimize distortions of the image.

The embodiment illustrated by FIG. 2 shows the optic 1 depicted in FIG. 1 mounted on the end of a digital video camera housing 6 by a mounting adapter 7, the axis of rotation of surfaces 1a and 1b being coincident with the optical axis of the video camera lens system 3. Is used as an edge that is used to provide an outline that would later be eliminated in the video processing software and eliminate excess light from entering the lens. Light entering the lens passes through surface lb, is then reflected by la, through lens system 3, and is directed to the digital mosaic filter 10 then to the image sensor 11 (CCD or CMOS) which captures a instance of the image which is made up of digital pixels the computer then takes multiple images and records each one to be presented in sequence of images as was once called moving pictures or now known as video. If the embodiment is used with the axis of the camera lens system vertical, the maximum angle of acceptance of light above the horizon as represented by ray 12 and 14 is governed by the focal angle alpha, whereas the maximum acceptance of light below the horizon as represented by the ray 13 and 15 is governed only by the angle alpha, which must be less than 45° if a ray 13 and 15 is to be below the horizon. It is critical for the apex of the inverted mirrored cone or sphere formed by the rotation of surface la to be located above the plane 1c so that the maximum angle of acceptance of light below the horizon is accommodated by the panoramic optic 1.

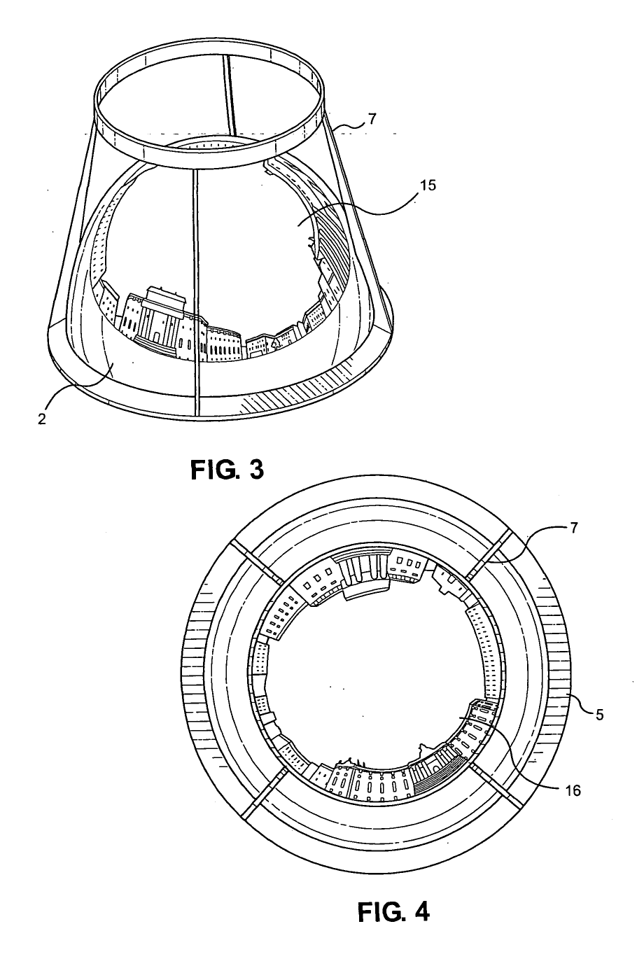

With the axis of lens system 3 of the embodiment illustrated by FIG. 2 vertical, the objects represented spatially by FIG. 3 will appear on the film as shown by FIG. 4, the line 14 will be an imaginary line representing the realistic horizon of the embodiment illustrated by FIG. 2. The system can be mounted onto a fixed mount onto the rear mirror as embodiment illustrated in FIG. 4. The optic should be positioned lower than the mirror in such a manner to be low enough to capture all windows: front, passenger, drivers and rear window in order to capture all details of the environment outside the vehicle. The optic will also capture the actions of the driver. This would be significant in regards to determining what the driver's actions were at the time of the recording.

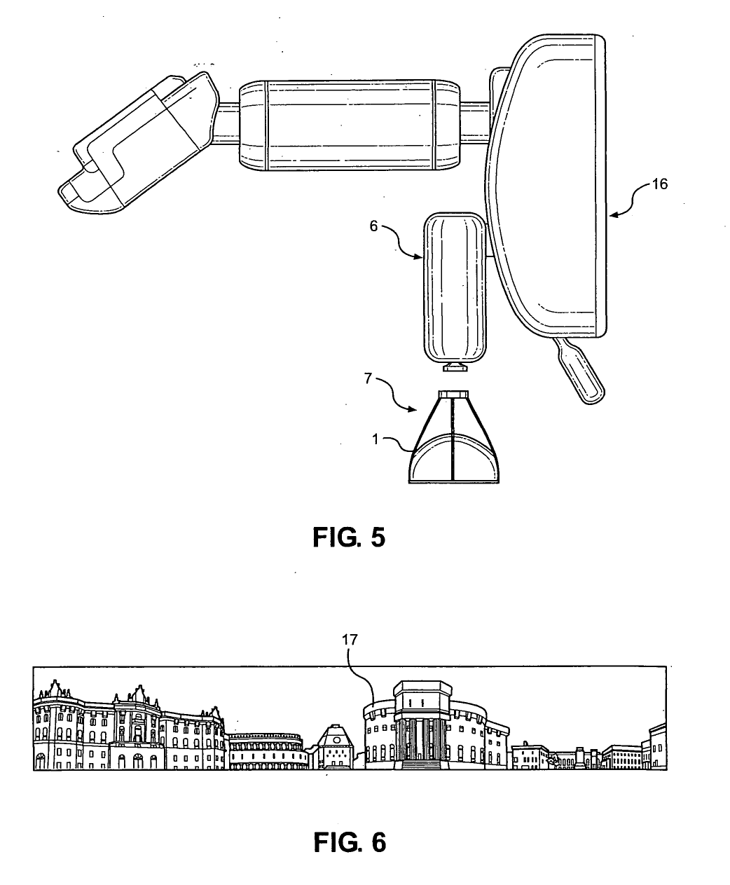

In the further embodiment illustrated by FIG. 5, using the software package the cylindrical image can be converted to a rectangle image. The standard software package employed can digitize circular images and the individual pixel image position can be calculated and using the computer algorithm the pixel points can be repositioned into a rectilinear image for easier viewing.

What is claimed is:

1. A 360° panoramic view of the surroundings is captured using a apparatus comprising:
a video CCD video camera;
a conical optic fixture at mounted to the video camera at a focal length;
a conversion software that transforms the image captured to rectilinear image.

2. The conical optic of claim 1 would be a mirrored surface.

3. The apparatus of claim 1 would be mounted onto a review mirror such that the conical optic is positioned below the mirror.

4. The apparatus of claim 1 can be mounted into any environment that a panoramic view is desired.

5. The rectilinear image of claim 1 would need to be scaled to eliminate the distortion of the conical optic.

6. The conversion software of claim 1 would be integrated into the video camera so the output is only in rectilinear format.

7. A 360° panoramic view of the surroundings is captured using a apparatus comprising:
a video CCD video camera;
a spherical optic fixture at mounted to the video camera at a focal length;
a conversion software that transforms the image captured to rectilinear image.

8. The spherical optic of claim 7 would be a mirrored surface.

9. The apparatus of claim 7 would be mounted onto a review mirror such that the spherical optic is positioned below the mirror.

10. The apparatus of claim 9 can be mounted into any environment that a panoramic view is desired.

11. The rectilinear image of claim 7 would need to be scaled to eliminate the distortion of the spherical optic.

12. The conversion software of claim 7 would be integrated into the video camera so the output is only in rectilinear format.

12. A 360° panoramic view of the surroundings is captured using a apparatus comprising:
a video CCD video camera;
a parabola optic (function of y=x²) fixture at mounted to the video camera at a focal length;
a conversion software that transforms the image captured to rectilinear image.

13. The parabola optic of claim 12 would be a mirrored surface.

14. The apparatus of claim 12 would be mounted onto a review mirror such that the spherical optic is positioned below the mirror.

15. The apparatus of claim 12 can be mounted into any environment that a panoramic view is desired.

16. The rectilinear image of claim 12 would need to be scaled to eliminate the distortion of the parabola optic.

17. The conversion software of claim 12 would be integrated into the video camera so the output is only in rectilinear format.
